(19) United States
(12) Patent Application Publication
(10) Pub. No.: US 2010/0024619 A1
(43) Pub. Date: Feb. 4, 2010

(54) DEVICE AND METHOD FOR MACHINING A SOLID MATERIAL USING A WATER JET

(75) Inventors: Thomas Loerting, Rum (AT); Bertel Erminald, Innsbruck (AT)

Correspondence Address: Workman Nydegger;1000 Eagle Gate Tower, 60 East South Temple, Salt Lake City, UT, 84111, US

(73) Assignee: UNIVERSITAT INNSBRUCK, Innsbruck (AT)

(21) Appl. No.: 12/305,741

(22) PCT Filed: Jun. 22, 2007
(86) PCT No.: PCT/AT2007/000307

§ 371 Date: Mar. 2, 2009

(30) Foreign Application Priority Data
Jun. 23, 2006 (AT) A 1066/2006

(51) Int. Cl. B26F 3/00

(52) U.S. Cl. 83/177

(57) ABSTRACT

A method of machining a solid material using a water jet discharging from a nozzle is specified, wherein the water jet contains ice crystals and impacts on the solid material. In this case, a medium which is gaseous under standard conditions is dissolved in water at a mixing stage under pressure (1-150 bar) and is then compressed to 1000-4500 bar and pressed through a nozzle, under conditions which allow the dissolved gaseous medium to bubble out after leaving the nozzle, whereupon the heat of solution is withdrawn from the water and the ice crystals are formed.

The invention relates to a device and a method for machining a solid material using a water jet discharging from a nozzle, said water jet containing ice crystals and impacting on said solid material.

Water jets or air jets—in particular under high pressure—are applied for the machining of various materials in manifold kinds. Said jet is usually expanded to ambient pressure through a narrow nozzle and is used for surface abrasion such as e. g. for primary cleaning, polishing, trimming/deburring, removal of coats or laminations, lacquer cleaning etc., or is used for cutting or drilling materials and workpieces, respectively. Also artistic activities such as “negative graffiti”—which means drawing by selective removal of paint by the slim water or air jet—are possible.

Examples of known devices for machining materials are, for instance, disclosed in DE 198 49 814 A1 as well as in DE 198 49 813 A1, in which an abrasive material is fed. From DE 10 2004 046 030 A1 a method and device for cutting a web is known, wherein ice crystals are formed in the water jet. The formation of the ice crystals can be supported by admixing carbon dioxide to the water in the high pressure section before the nozzle, said carbon dioxide evaporating after discharging, whereupon the evaporation heat of the carbon dioxide withdraws energy from the water.

The known methods and devices for cutting or drilling materials, however, are only suitable for the machining of soft materials. Hard materials like steel can only be machined abrasively, i.e. the water jet must contain solid particles such as for example sand, corundum, or similar abrasives. Thereby, it is particularly disadvantageous that the workpieces can be contaminated by the abrasive when, for example, sand remains on the surface or in the cracks and has to be removed elaborately.

Moreover, the generation of ice crystals in an air jet or waterjet is known, wherein the ice crystals replace the sand or other abrasives in the air jet or water jet. An apparatus for pre-cooling the water using a cryogenic liquid in order to generate ice crystals in the water jet is, for example, disclosed in U.S. Pat. No. 5,341,608.

However, this method has the disadvantage that the ice crystals are generated already before the nozzle and that thereby it frequently occurs that the nozzle gets eroded or congested, or is overheated by the increased friction, whereby the ice crystals melt again.

The object of the invention is, therefore, to disclose a method and a device for machining a solid material using a water jet, said method offering a simple and cost-effective possibility for the formation of ice crystals in the water jet after the discharge of the water jet from the nozzle.

According to the present invention, it is provided that the method for machining a solid material using a water jet discharging from a nozzle, said water jet containing ice crystals and impacting on the solid material, is characterized in that a medium which is gaseous under standard conditions is dissolved in the water at a pressure of 1-150 bar, preferably at a mixing stage. The solution is subsequently compressed to 1000-4500 bar at a high-pressure stage, e.g. in a commercial water-jet cutting machine, and is pressed through a nozzle under conditions which allow a separation of the water and the dissolved medium after leaving the nozzle, whereupon the heat of solution is withdrawn from the water and ice crystals are formed.

This is advantageous because thereby the ice crystals are formed on the one hand with little effort and on the other hand after streaming through the nozzle, and consequently abrasion of the nozzle, clogging of the nozzle by the ice crystals formed and heating of the nozzle due to the high friction and subsequent melting of the ice crystals can be prevented.

Further advantageous embodiments of the present invention arise from the dependent claims.

Advantageously, the dissolving of the gaseous medium in the water is carried out in a simple and cost-effective manner at the mixing stage by passing the gaseous medium from gas cylinders or pressure cartridges through the water under pressure.

Furthermore, it is advantageous that a modulation of the concentration of the gaseous medium in solution and of the pre-cooling of the water governs the particle fraction and the particle size of the ice crystals formed in the water jet, because thereby a simple adaptation of the physical properties of the water jet to the material to be machined is rendered feasible.

It is particularly advantageous that the gaseous medium is carbon dioxide, because this can be produced in a simple and cost-effective manner and is above all applicable in food industry.

Advantageously, a preferred embodiment of a device for machining a solid material using a water jet discharging from a nozzle, said water jet containing ice crystals and impacting on the solid material, comprises a feed pipe with an inlet valve and a pump for pumping water into a mixing section in which the pressure is 1-150 bar, a high pressure resistant vessel connected with the mixing section via a high pressure pump and a nozzle connected with this vessel, wherein a gaseous medium is introducible under pressure within the mixing section into the water which is fed into the mixing section via the feed pipe, and is soluble in the water, because this embodiment represents a simple and cost-effective possibility for dissolving a gas in water.

Furthermore, it is advantageous that the gaseous medium is introducible into the water via a douche gadget arranged in the mixing section, said douche gadget in particular being designed in the form of a shower head with a multiplicity of outlets, because this allows for a uniform distribution of the gaseous medium across a large volume.

Advantageously, the gaseous medium is introducible into the water upstream with respect to the mixing section under a pressure of 1-150 bar, whereby additional devices for introducing the gaseous medium into the water can be avoided in favor of the saving of costs.

An advantageous embodiment of the invention provides that the gaseous medium is provided in the mixing section under a pressure of 1-150 bar and the water is fed in by nebulizing, because this permits a very homogeneous intermixture.

An also very advantageous embodiment of the invention provides that the gaseous medium is introducible into the water via dry ice pellets which contain said gaseous medium and that the gaseous medium is soluble in the water under pressure, because, in doing so, tank devices and inlet pipes for the gaseous medium can be avoided.

Moreover, it is advantageous that the gaseous medium is fed to a mixing stage for the purpose of mixing it with the water at a medium pressure range (1-150 bar). In doing so, it is possible in a simple manner to use commercial storage tanks for gaseous media in particular in the form of a gas cylinder or of a gas cartridge.

In addition, it is advantageous that the mixing section is connected with a return pipe, through which excessive gaseous medium can be fed back into the feed pipe, because thereby excessive gaseous medium can be recycled.

Furthermore, it is advantageous that the water is pressed through the nozzle under a pressure of 1000-4500 bar, because this permits a large temperature drop and correspondingly the reliable formation of ice crystals during the expansion of the water jet to ambient pressure.

In the following, a preferred exemplary embodiment of a device which is suitable for the implementation of the method according to the invention for machining a solid material using a water jet is described in further detail by means of the figures. In the drawings,

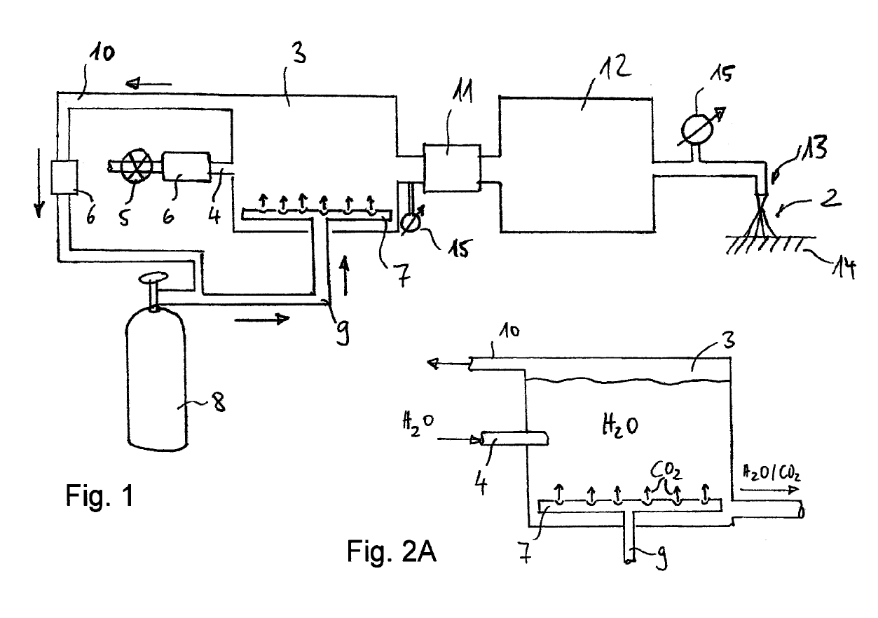

FIG. 1 shows a strongly schematized view of a preferred exemplary embodiment of a device designed according to the invention for machining a solid material using a water jet, and

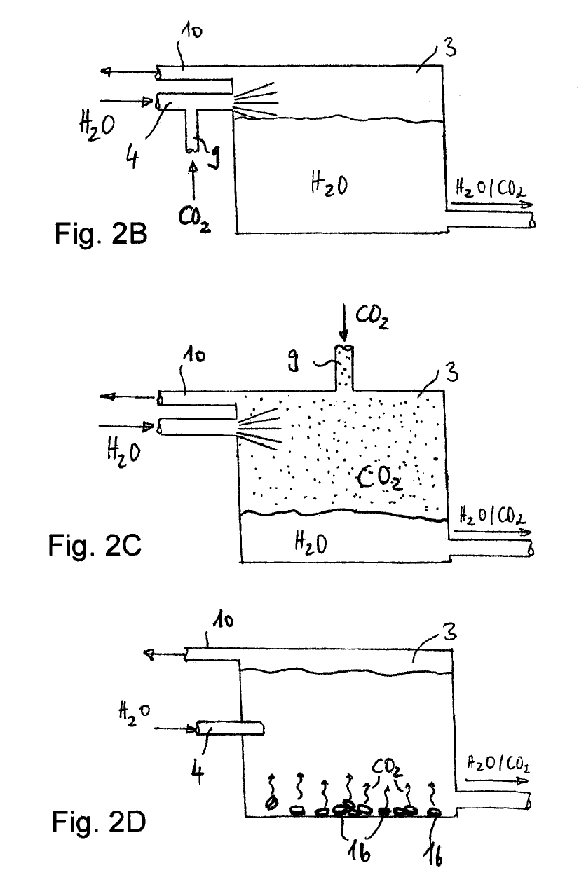

FIGS. 2A-D show four exemplary embodiments of mixing sections of the device according to the invention as shown in FIG. 1.

As already mentioned above, the addition of abrasives to the water jet is essential for the machining of solid materials when harder materials or surfaces are to be machined, wherein preferably sand is applied, which, however, has a series of disadvantages. Sand and other solid abrasives remain on the treated material and have to be removed thereafter. A major advantage of the application of ice crystals as an abrasive instead of sand is the prevention of contamination. The ice crystals melt after the machining and the remaining water can be removed by e.g. simple drying, whereby the treated material remains clean throughout the entire process. Additionally, the application involves an environmental advantage, because no sand waste accumulates which has to be eliminated or recycled. A water jet loaded with ice crystals as an abrasive can, therefore, promptly be employed in branches like electronics, (bio-)medicine, foods, car lacquers, astronautics, etc. Also the costs are less, because ice—contrary to other abrasives like sand—does not have to be delivered and stocked, but for example can be fabricated from tap water by the use of electricity.

Known methods for admixing ice into the water jet, however, are afflicted with a series of disadvantages. In particular the generation of ice crystals in the flow direction in front of the nozzle causes the nozzle to be eroded or to be congested or—by the augmented friction—to be heated up to an extent which makes the ice crystals melt again. Due to this so-called ex-situ mixing procedure, a minimum diameter of the water jet is required, which finally leads to a limitation of maximum pressure and energy efficiency. The high costs for the production of the ice crystals and correspondingly the high technical complexity and space requirement are further disadvantages of this method.

For the formation of the ice crystals in situ, it is however necessary to work at temperatures of 243 K or below, because water at a pressure of e.g. 200 MPa freezes only at 253 K (i.e. at 20 K lower than at atmospheric pressure) and additionally tends to super-cool. Furthermore, the sintering of ice particles is inhibited effectively only below 243 K, because above 243 K a thin liquid film (in the scale of nanometers) on the ice surface leads to sintering. In order to suppress the super-cooling, one can in principle add nucleating agents. These are organic or inorganic solid materials which represent seeds for the growth of the ice crystals. However, the application of nucleating agents, which have to be fed continuously via an aspiration port, again brings about the problem of bad environmental compatibility, whereby an application in food industry is no longer possible.

For avoidance of the mentioned disadvantages, the present invention provides that the cooling-down of the water and hence the formation of ice particles in the water jet are achieved in that a gaseous medium, e.g. carbon dioxide, is dissolved in water in a mixing device at a pressure of 1-150 bar, and then said mixture is led to a nozzle using a high pressure pump. Due to the decrease of pressure after the nozzle, a demixing takes place. The release of the gaseous medium withdraws the heat of solution of the gaseous medium from the water in addition to the cooling-down by expansion, which leads to a spontaneous cooling-down and to the formation of ice crystals in the water jet after the nozzle. The cooling-down thus achieved lies in the range of several degrees Celsius so that substantially less effort has to be invested into the cooling system of the device. Also the problems of abrasion and congestion of the nozzle can be avoided by those means. The described approach to a solution is in principle possible with a multitude of gaseous media, because many gases are soluble in water very well. Due to the possibility of applying carbon dioxide (CO₂) in the potable water industry as well as due to the comprehensive state of knowledge concerning the physical and chemical properties—such as e.g. solubility in water and heat of solution—the invention is in the following specified using the example of CO₂.

FIG. 1 shows—in a strongly schematized view—an exemplary embodiment of a device 1 for machining solid materials using a water jet 2, preferably using a high pressure water jet, said jet containing a gas admixture. The device 1 thereby essentially comprises a mixing section 3 in which the water and a gaseous medium—in said exemplary embodiment carbon dioxide—are mutually intermixed. At this, the water is led into the mixing section 3 under low pressure (i.e. for example the operating pressure of the water distributing network) via a feed pipe 4 having an inlet valve 5 and a pump 6. The carbon dioxide is introduced into the mixing section 3 from a tank 8 (e.g. a gas cylinder) via a feed pipe 9, using for example a douche gadget 7. In this, the douche gadget 7 is for example designed in the form of a shower head with a multiplicity of outlets, through which the gaseous medium streams into the water in the mixing section 3. A return pipe 10 with a further pump 6 permits the feeding back of excessive gaseous medium into the feed pipe 9. In doing so, the pressure in the mixing section 3 amounts to circa 200 bar, which in the following is denoted as intermediate pressure.

After the dissolving of the gaseous medium in the water, said water is—via a pump 11—brought up to a pressure of approx. 4000 bar, which in the following is denoted as high pressure, and is transferred into a vessel 12 in order to stream from there to a nozzle 13. Using the water jet 2 being squeezed through the nozzle 13 under high pressure and discharging from said nozzle, the material 14 is machined. The monitoring of pressure and flow rate of the water is carried out using suitable measuring devices 15 which can be situated at various adequate spots of device 1.

According to the invention, the formation of the ice crystals occurs not until after the nozzle 13. The formation of crystals is initiated by the expansion and correspondingly the nebulization of the water jet 2, which leads to a sudden bubbling out and release of the dissolved carbon dioxide from the now oversaturated gas-water solution. A heat of solution quantity of −20.54 kJ/mol is thereby withdrawn from the water. Depending on the initial pressure of the water, this leads to an instantaneous, very intense cooling and to the spontaneous formation of ice crystals in the expanded water jet 2. Consequently, problems like congestion, abrasion or overheating of the nozzle 13 can be avoided. An appropriate modulation of the concentration of the CO₂ in solution and of the pre-cooling thereby permits a control of the particle fraction and of the particle size in the water jet 2 so that said jet can be adapted to the respective requirements of the material 14 to be machined, for example with many large ice crystals for a quick and rather rough cleaning of huge surfaces, or with many small ice crystals for polishing a surface. Also hard materials 14 can be machined precisely.

The admixing of the carbon dioxide in the mixing section 3 can—as is shown in FIG. 2A-D in schematic cut-outs—be carried out directly in the mixing section 3, as already depicted in FIG. 1 as well as scaled up in FIG. 2A.

Also by providing in the mixing section 3 a gaseous medium compressed to approx. 200 bar and by subsequently nebulizing water droplets and by injecting them into this system, as is illustrated in FIG. 2C, it is possible to achieve an effective mixing and dissolution of the gas.

Moreover, it is possible—as schematically shown in FIG. 2D—to provide water in the mixing section 3, then to insert dry-ice pellets 16 (i.e., frozen carbon dioxide pellets 16) having a temperature of approx. −78° C. into the mixing section 3 and to apply pressure subsequently. In the—compared to the pellets 16 relatively warm—water, the pellets 16 melt immediately with intense bubble formation, the carbon dioxide being dissolved simultaneously due to the pressure. Additionally, the water is cooled too, which is advantageous with regard to the formation of ice crystals in the further course.

In all cases, a saturated mixture of water and carbon dioxide leaves the mixing section 3 towards the vessel 12.

In the mixing section 3, the water is initially mixed with carbon dioxide by dissolving the CO₂ in the water, e.g. by leading through CO₂ from the tank 8, which in the exemplary embodiment illustrated in FIG. 1 is designed in the form of a gas cylinder. The usage of pressure cartridges, as known for carbonated water, is possible as well. The process of dissolving carbon dioxide in water can be supervised by monitoring the pH-value via a suitable sensor, because—due to the reaction equilibrium between CO₂/H₂O and HCO₃⁻/H⁺—solutions saturated with CO₂ are acidic; for example at 298 K, a pH-value of 3.9 results. The temperature of the device 1 slightly increases due to the heat of solution of the carbon dioxide, which consequently suggests heat removal from the mixing section 3, e.g. via a water cooling system.

The water jet 2 is generated by pumping the water-CO₂-mixture using the pump 11, which has to be designed appropriately for high pressures, into the vessel 12 and then leading it to the nozzle 13 and squeezing it through said nozzle. For this purpose, existing pumps 11 and nozzles 13 can be used without any further technical modifications. Nor any further materials have to be fed from the outside either, i.e. no additional aspiration port is necessary.

The estimate indicated in the following may serve as an idea for the extent of the achievable cooling-down. The achievable temperature difference is calculated via the number of moles of the dissolved carbon dioxide (n_{CO2}), the number of moles of the water (n_{H2O}), the isobaric heat capacity of liquid water (cp_{H2O}=75.3 J/(K*mol)) and the enthalpy of solution of carbon dioxide in water (ΔH=−20.54 kJ/mol). Up to a pressure of ca. 300 bar CO₂, the mole fraction of carbon dioxide n_{CO2}/nₜₒₜₐₗ (i.e. the fraction of the CO₂ molecules dissolved in the water) can be expressed linearly by the partial pressure of the CO₂ via Henry's law. The constant of proportionality of Henry's law is k_{CO2}=1650 bar for CO₂. As long as the partial pressure of CO₂ p_{CO2} is much smaller than k_{CO2}, the cooling-down is given by a relation linear in p_{CO2} with a proportionality constant of ΔH/(cp_{H2O}*k_{CO2}), which by inserting the known values results in a proportionality constant of 0.165 K/bar. Hence, per bar of dissolved CO₂ the temperature decreases by 0.165 K, which, correspondingly, results in as much as 16.5 K for 100 bar.

Starting with cold tap water at ca. 10° C., then the leakage of CO₂ dissolved at 100 bar would already suffice to reach temperatures below the freezing point. There, the cooling by the expansion of the water jet 2 from the vessel 12 at 4000 bar to 1 bar after the nozzle 13 is not taken into account yet. At ambient pressure, 3.4 g CO₂ are soluble in one litre of water at 273 K and accordingly 1.5 g are soluble at 298 K This corresponds to 1.93 litres and accordingly 0.85 litres of CO₂ per litre of water (i.e. 0.077 mol and 0.034 mol, respectively). At increased pressure, e.g. in carbonated mineral water, considerably bigger quantities are soluble.

The released carbon dioxide can, if required, be recycled or withdrawn by suction. Yet, it has to be ensured that the admixing of carbon dioxide to the ambient air does not become too severe, because otherwise the danger of suffocation exists—e.g. by ventilation or by appropriately big rooms.

The present invention is not limited to the exemplary embodiment described above, but can for example also be executed with other gaseous media.

1. A method for machining a solid material using a water jet discharging from a nozzle, said water jet containing ice crystals and impacting on the solid material, comprising:
at a pressure of 1-150 bar, dissolving in water a gaseous medium which is gaseous under standard conditions,
subsequently compressing the water with the dissolved gaseous the medium 1000-4500 bar, and
forming the water jet by pressing the water with the dissolved gaseous medium through a nozzle under conditions which allow the dissolved gaseous medium to bubble out after leaving the nozzle, whereupon the heat of solution is withdrawn from the water and ice crystals are formed.

2. The method according to claim 1, wherein the dissolving of the gaseous medium in the water is carried out at a mixing stage by:
passing the gaseous medium from gas cylinders or pressure cartridges through the water at a pressure of 1-150 bar, or
inserting dry ice pellets into the water, said pellets containing the gaseous medium.

3. The method according to claim 1, wherein a modulation of the concentration of the gaseous medium in solution and of the temperature of the water governs the particle fraction and the particle size of the ice crystals formed in the water jet.

4. The method according to claim 1, wherein the gaseous medium is carbon dioxide.

5. A device for machining a solid material using a water jet discharging from a nozzle, said water jet containing ice crystals and impacting on the solid material, comprising:
a feed pipe with an inlet valve,
a first pump for pumping water into a mixing section;
a vessel connected with the mixing section via a second pump and a nozzle connected with the vessel, wherein:
a gaseous medium is introducible under pressure before or in the mixing section into the water, which is fed into the mixing section via the feed pipe, and is soluble in the water.

6. The device according to claim 5, wherein the gaseous medium is introducible into the water via a douche gadget arranged in the mixing section, said douche gadget being in the form of a shower head with a multiplicity of outlets.

7. The device according to claim 5, wherein the gaseous medium is introducible into the water upstream with respect to the mixing section under a pressure of 1-150 bar.

8. The device according to claim 5, wherein the gaseous medium is provided in the mixing section under a pressure of 1-150 bar and the water is fed in by nebulizing.

9. The device according to claim 5, wherein the gaseous medium is introducible into the water via dry ice pellets which contain said gaseous medium and that the gaseous medium is soluble in the water under pressure.

10. The device according to claim 5, wherein the gaseous medium is provided in a tank in the form of a gas cylinder or a gas cartridge and from which said gaseous medium can be supplied to the device via another feed pipe.

11. The device according to claim 10, wherein the mixing section is connected with a return pipe, through which excessive gaseous medium can be fed back into the other feed pipe.

12. The device according to claim 5, wherein the water is pressed through the nozzle under a pressure of 1000-4500 bar.

13. The device according to claim 5, wherein said gaseous medium is carbon dioxide.
